(19) United States
(12) Patent Application Publication
(10) Pub. No.: US 2025/0189449 A1
(43) Pub. Date: Jun. 12, 2025

(54) SMALL-MOLECULE PROBE BASED ON FLUORESCENCE SENSING AND USE THEREOF

(71) Applicant: Jianghan University, Wuhan (CN)

(72) Inventors: Xunchang WANG, Wuhan (CN); Renqiang YANG, Wuhan (CN); Jingyi XIONG, Wuhan (CN); Yirui LIU, Wuhan (CN)

(73) Assignee: Jianghan University, Wuhan (CN)

(21) Appl. No.: 19/056,845

(22) Filed: Feb. 19, 2025

(30) Foreign Application Priority Data
Nov. 29, 2024 (CN) 202411741191.7

(51) Int. Cl. G01N 21/64; G06V 10/25; G06V 10/56; G06V 10/74; G06V 10/764; G06V 10/77; G06V 10/82; G06V 10/94

(52) U.S. Cl. CPC G01N 21/6428; G01N 21/6456; G06V 10/25; G06V 10/56; G06V 10/74; G06V 10/764; G06V 10/7715; G06V 10/82; G06V 10/95; G01N 2021/6439

(57) ABSTRACT

The intelligent real-time monitoring system for nitro explosives in the present disclosure adopts a PP-YOLO algorithm, and can capture. Combining fluorescence and colorimetric images with the assistance of an optical camera. The fluorescent probe TPE-J is designed and synthesized for the dosage-sensitive and visual detection of nitro explosives. The electron transfer between picric acid (PA) and the probe causes a specific response that the original blue fluorescence is rapidly quenched to non-luminescence within 5 s, with a detection limit as low as 1 mg/mL. A color change can be integrated into an optical camera for capture and quantization, and the resulting image data is automatically processed by a deep learning algorithm platform. The sensing system facilitates the efficient real-time monitoring and highly-sensitive detection of PA in various scenarios. The fluorescence sensing-based detection platform with deep learning provides a new perspective for the efficient portable detection of explosives.

### CROSS-REFERENCE TO RELATED APPLICATIONS

This application claims priority to Chinese Patent Application No. 202411741191.7 with a filing date of Nov. 29, 2024. The content of the aforementioned application, including any intervening amendments thereto, is incorporated herein by reference.

### TECHNICAL FIELD

The present disclosure relates to the technical field of fluorescent probes, and in particular to a small-molecule probe based on fluorescence sensing and a use thereof.

### BACKGROUND

Explosives have been most commonly used by terrorist organizations to carry out terrorist acts. This is because the manufacture and use of explosives are relatively simple and explosives can cause countless deaths and extensive property damage. The use of fluorescence sensing technologies to accurately recognize and trace-monitoring the existing nitro explosives and derivatives thereof can effectively suppress the terrorist activities and maintain the public safety. The fluorescence sensing technologies have advantages such as fast responses, convenient operations, and visualization, and are considered to be suitable for the on-site motion detection, and especially suitable for the civilian and police scenarios. However, the fluorescence sensing technologies still rely on sophisticated optical devices and trained technicians, which limit the application of the fluorescence sensing technologies in motion detection scenarios. In addition, the complex spectral information further increases the detection time, and makes it impossible to quickly acquire accurate and trace-quantitative detection results. Compared with the complex spectral data monitoring process, the conversion of spectral data results into image information output especially before the long-term real-time recording and analysis is conducive to the accurate and fast data visualization. However, how to reduce the consumption of human resources and improve the speed, accuracy, and portability of detection while achieving the rapid data visualization limits the further development of fluorescence sensing technologies for nitro explosives.

Deep learning, which enables a machine to learn from a large amount of data to replicate the human intelligence, has proven to be one of the most effective tools for image data processing. During the detection of explosives by a fluorescence sensing technology, a large amount of fluorescence image data will be generated. If the fluorescence image data is processed by the traditional RGB value reading method, there will be low efficiency and greatly-reduced accuracy. In contrast, the deep learning, especially convolutional neural networks (CNNs), performs well in terms of automatically extracting image features. The deep learning can recognize complex patterns and structures in images, and exhibits superior performance in terms of the speed and accuracy of image processing.

### SUMMARY OF PRESENT INVENTION

An objective of the present application is to provide a small-molecule probe based on fluorescence sensing and a use thereof. The present application is intended to solve the problems in the prior art.

An embodiment of the present application provides a small-molecule probe with a structure as follows:

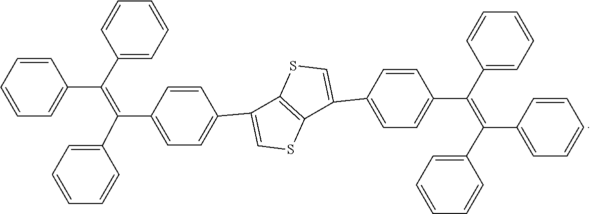 [SMILES: c1ccc(C(=C(c2ccccc2)c2ccc(-c3csc4c(-c5ccc(C(=C(c6ccccc6)c6ccccc6)c6ccccc6)cc5)csc34)cc2)c2ccccc2)cc1]

A synthesis method of the small-molecule probe is provided, including: degassing a mixture of 3,4-dibromothiophene, (4-(1,2,2-triphenylvinyl)phenyl)boronic acid, toluene, potassium carbonate, distilled water, tetrakis (triphenylphosphine) palladium, and absolute ethanol to produce a degassed mixture, and subjecting the degassed mixture to stirring and reflux at 90° C. under nitrogen for 24 h.

The 3,4-dibromothiophene, the (4-(1,2,2-triphenylvinyl)phenyl)boronic acid, and the potassium carbonate are in a molar ratio of 1:3:8; the toluene, the distilled water, and the absolute ethanol are in a volume ratio of 6:4:3; 0.75 mL of the toluene is required per millimole of the potassium carbonate; and an equivalent of the tetrakis(triphenylphosphine)palladium is 0.02 times an equivalent of the 3,4-dibromothiophene.

A use of the small-molecule probe in detection of a picric acid (PA)-containing explosive is provided.

A fluorescent sensor immobilized with the small-molecule probe is provided.

Further, the fluorescent sensor is a paper-based fluorescent sensor or a hydrogel-based fluorescent sensor film.

A portable explosive detection platform is provided, including a notebook computer, a closed box, an ultraviolet (UV) light source, an optical camera, and a sample vial, where the sample vial is filled with the fluorescent sensor described above or the small-molecule probe described above.

A method for quantifying a PA content based on a fluorescence image-derived spectrum is provided, including: allowing the portable explosive detection platform described above or the fluorescent sensor described above or the small-molecule probe described above to bind to PA, and taking images by an optical camera; extracting RGB values from the images, and establishing a linear relationship of RGB and Hue, Saturation, Value (HSV) with PA concentrations; and calculating the PA content qualitatively and quantitatively through an equation for the linear relationship.

Further, image processing is conducted with a PP-YOLO model as follows: receiving input images by the PP-YOLO model, and conducting feature extraction with a deep convolutional neural network; enhancing a representation ability for multi-scale features with a feature pyramid network (FPN) and a path aggregation network (PANet); processing a feature map with a network to predict a class probability and bounding box coordinates of each region; matching a target with an anchor box, and eliminating overlapping predictions with non-maximum suppression (NMS); and conducting a post-processing step to filter and fine-tune results to obtain a final object detection result.

A cloud-based intelligent visual detection system produced by arranging the PP-YOLO model on a cloud platform is provided.

Beneficial effects of the present disclosure: The intelligent real-time monitoring system for nitro explosives in the present disclosure adopts a PP-YOLO algorithm, and can capture fluorescence and colorimetric images with the assistance of an optical camera. The fluorescent probe TPE-J is designed and synthesized for the dosage-sensitive and visual detection of nitro explosives (PA). The electron transfer between PA and the probe causes a specific response that the original blue fluorescence is rapidly quenched to non-luminescence within 5 s, with a detection limit as low as 1 mg/mL. A color change can be integrated into an optical camera for capture and quantization, and the resulting image data is automatically processed by a deep learning algorithm platform. The sensing system facilitates the efficient real-time monitoring and highly-sensitive detection of PA in various scenarios. The fluorescence sensing-based detection platform with deep learning provides a new perspective for the efficient portable detection of explosives.

### BRIEF DESCRIPTION OF THE DRAWINGS

FIG. 1 shows a hydrogen nuclear magnetic resonance spectrum of the small-molecule probe TPE-J;

FIG. 2 shows a carbon nuclear magnetic resonance spectrum of the small-molecule probe TPE-J;

FIG. 3 shows a synthesis path of the small-molecule probe TPE-J;

FIG. 4 shows a Stern-Volmer relationship between I₀/I−1 of the small-molecule probe TPE-J and PA concentrations, I=peak intensity, I₀=peak intensity without PA;

FIG. 5 shows a relationship between a fluorescence intensity and a wavelength for the small-molecule probe TPE-J and PA;

FIG. 6 shows a relationship between a quenching intensity and a time for the small-molecule probe TPE-J and PA;

FIG. 7 shows an image of a fluorescence quenching reaction between the small-molecule probe TPE-J and PA under the irradiation of a UV lamp in a darkroom;

FIG. 8 shows a density functional theory (DFT) computation structure for the small-molecule probe TPE-J and PA;

FIG. 9 shows a reaction mechanism of the small-molecule probe TPE-J with PA;

FIG. 10 is a flow chart of a method for processing a fluorescence image based on a PP-YOLO model;

FIG. 11 shows RGB values acquired by the image processing method at different PA concentrations;

FIG. 12 is a comparison diagram between analyte concentration values detected by the image processing method and actual analyte concentration values at different PA concentrations; and

FIG. 13 shows linear relationships for RGB values acquired by the image processing method at different PA concentrations, where a, b, c, and d show linear relationships between a PA concentration and photonic fluorescence channel R, G, B, and V value information, respectively, e shows a functional relationship between a PA concentration and photonic fluorescence channel value information ΔE, and f shows the comparison between an analyte concentration value detected with RGBVE and an actual analyte concentration value.

### DETAILED DESCRIPTION OF THE EMBODIMENTS

The technical solutions of the examples of the present disclosure are clearly and completely described below with reference to the accompanying drawings in the examples of the present disclosure. Apparently, the examples are merely some rather than all of the examples of the present disclosure. All other examples obtained by those of ordinary skill in the art based on the examples of the present disclosure without creative efforts should fall within the protection scope of the present disclosure.

In the following examples, unless otherwise specified, water used is deionized water.

In the following tests of the present disclosure, the hydrogen nuclear magnetic resonance spectroscopy is carried out on the AVANCE NEO 400 MHz nuclear magnetic resonance spectrometer of German Bruker, the solvent used is deuterated chloroform (CDCl₃), and tetramethylsilane (TMS) is adopted for calibration.

### Example 1 Synthesis Method of the Small-Molecule Probe TPE-J and Research on a Fluorescence Quenching Response of the Small-Molecule Probe TPE-J to PA

### 1. Synthesis Method of the Small-Molecule Probe TPE-J

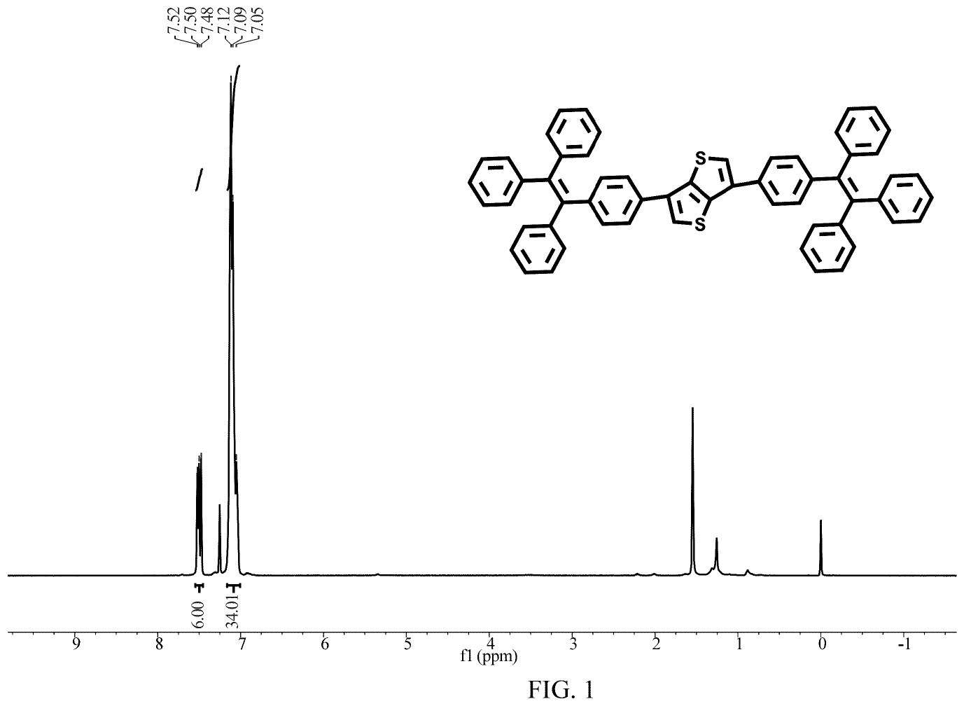

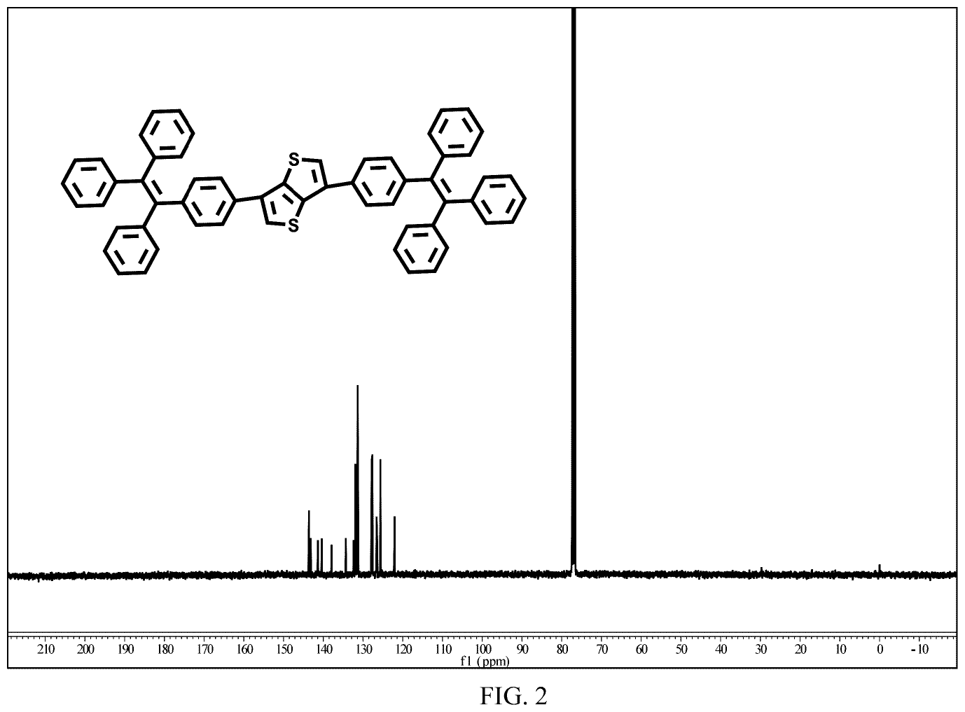

A mixture of 3,4-dibromothiophene (483.86 mg, 2 mmol), (4-(1,2,2-triphenylvinyl)phenyl)boronic acid (2.75 g, 6 mmol), toluene (12 mL), potassium carbonate (2.21 g, 16 mmol), distilled water (8 mL), tetrakis(triphenylphosphine)palladium (92.40 mg, 0.04 mmol), and absolute ethanol (6 mL) was degassed, and then subjected to stirring and reflux at 90° C. under nitrogen for 24 h to produce the small-molecule probe with a fluorescence response. A structure of the small-molecule probe (TPE-J) that was determined by hydrogen (FIG. 1) and carbon (FIG. 2) nuclear magnetic resonance spectroscopy was as follows:

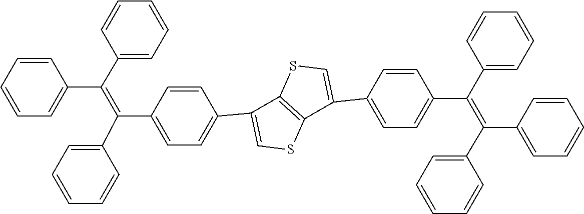 [SMILES: c1ccc(C(=C(c2ccccc2)c2ccc(-c3csc4c(-c5ccc(C(=C(c6ccccc6)c6ccccc6)c6ccccc6)cc5)csc34)cc2)c2ccccc2)cc1]

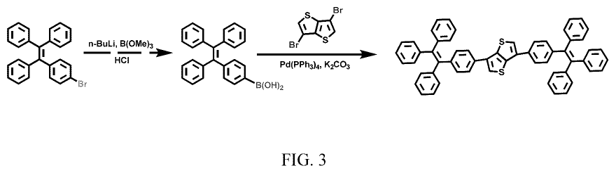

A synthesis path was shown in FIG. 3. The 3,4-dibromothiophene, the (4-(1,2,2-triphenylvinyl)phenyl)boronic acid, and the potassium carbonate were in a molar ratio of 1:3:8. The toluene, the distilled water, and the absolute ethanol in a volume ratio of 6:4:3 were adopted as a solvent. 0.75 mL of the toluene was required per millimole of the potassium carbonate. An equivalent of the tetrakis(triphenylphosphine)palladium was 0.02 times an equivalent of the 3,4-dibromothiophene.

### 2. Research on a Fluorescence Quenching Response of the Small-Molecule Probe TPE-J to PA

The probe TPE-J synthesized above was diluted to 1 μM with tetrahydrofuran (THF) for fluorescence spectroscopy. A time-dependent UV-visible spectroscopy study was conducted for TPE-J and PA in a THF aqueous solution (THF:water (volume ratio)=1:9). A UV-visible absorption spectrum was measured on a Hitachi UV-3900 UV-visible spectrophotometer.

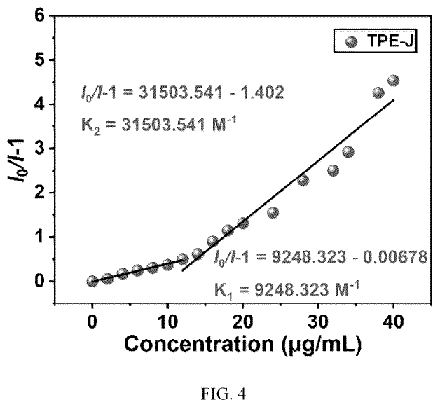

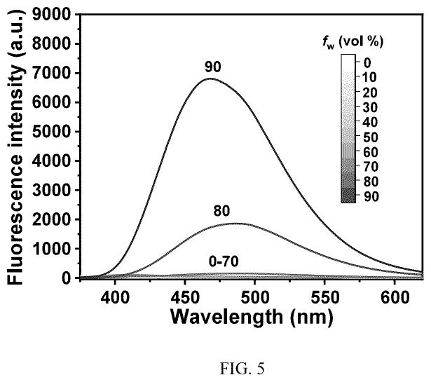

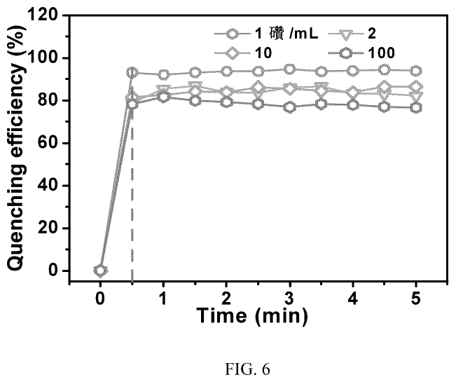

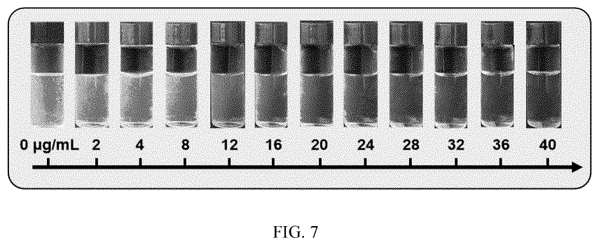

Results are as follows: A linear relationship between fluorescence quenching intensities and PA concentrations is shown in FIG. 4. The concentration of TPE-J is 1 μM. I represents a peak intensity, and I₀ represents a peak intensity in the absence of PA. A relationship between fluorescence intensities and wavelengths is shown in FIG. 5, and an emission wavelength of TPE-J can be determined accordingly. As shown in FIG. 6, kinetic determinations show that a reaction of TPE-J with PA at a final concentration of 40 μg/mL basically reaches equilibrium within 30 s. The visualization of fluorescence quenching is achieved by darkroom imaging. A fluorescence image under the irradiation of a 365 nm UV lamp in a darkroom is shown in FIG. 7.

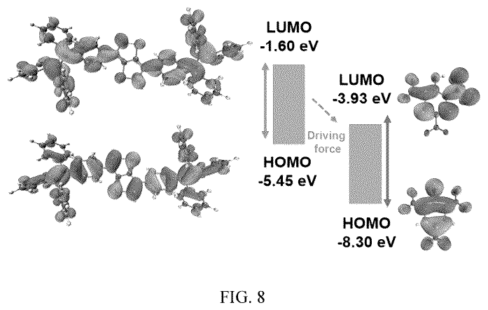

The Gaussian 16 software package was used to conduct the DFT computation for the probe TPE-J and PA. In the absence of conductor-like polarizable continuum model (C-PCM) as a solvation model, an energy level was calculated by a B3LYP/6-31G(d,p) method. Calculation results are shown in FIG. 8. A molecular orbital (MO) diagram and MO energy levels were calculated at a same theoretical level. In the geometric optimization of the two molecules, highest occupied molecular orbital (HOMO)-lowest unoccupied molecular orbital (LUMO) gaps of the TPE-J and PA are 3.93 eV and 5.45 eV, respectively. PA exhibits a wider bandgap and lower LUMO than TPE-J. In general, a nitro compound with a relatively-low LUMO energy level can accept an excited electron from an aggregation-induced emission (AIE) molecule to quench the fluorescence of the AIE molecule. An LUMO energy gap between an AIE sensor and a nitro compound is considered a driving force. An electrostatic potential surface (EPS) of the probe was investigated by a natural bond orbital method to evaluate the preferred response sites of the probe to PA. It was observed that extreme values of the probe were located at a thiophene ring of the molecule and an adjacent benzene ring moiety (red region), indicating that this region had a strong attraction for PA. Many polynitro-substituted aromatic explosives are essentially electron-deficient, and can bind to electron-rich substances through donor-acceptor interactions.

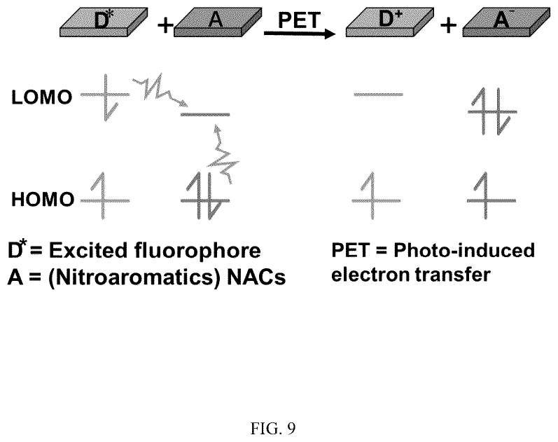

As shown in FIG. 9, a reaction mechanism between the probe TPE-J and PA is as follows: A photoinduced electron transfer (PET) reaction occurs between an electron-rich group of the probe (TPE-J) and electron-deficient PA to achieve a fluorescence response. The probe undergoes a rapid reaction with PA, and with the release of a PA solution, the chemical reaction is increasingly complete. In a PET process, a fluorophore donor in an excited state provides an electron acceptor to LUMO. The electron-rich TPE-J interacts with an electron-deficient nitroaromatic molecule through an electrostatic interaction, which is conducive to the highly-sensitive detection of explosives.

### Example 2 Use of the Small-Molecule Probe TPE-J in a Fluorescent Sensor

The small-molecule probe TPE-J was immobilized on a carrier to prepare a fluorescent sensor responsive to PA explosives. The fluorescent sensor included a paper-based fluorescent sensor and a hydrogel-based fluorescent sensor film.

The paper-based fluorescent sensor was prepared by loading the small-molecule probe TPE-J with a fluorescence response on a paper-based carrier through solution deposition. The hydrogel-based fluorescent sensor film was a hydrogel carrying the fluorescent probe that was prepared by compounding the small-molecule probe TPE-J with a fluorescence response and agarose. The hydrogel can adsorb and detect PA solid particles through a three-dimensional porous structure, and exhibits prominent mechanical properties.

A structural formula of agarose is as follows:

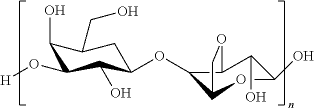

A preparation method of a hydrogel film carrying the fluorescent small-molecule probe was as follows: The small-molecule probe TPE-J with a fluorescence response was mixed with an agarose hydrogel according to a mass ratio of 1:200, and a reaction was conducted in water for 5 min to produce the hydrogel carrying the fluorescent probe.

### Example 3 Use of the Small-Molecule Probe TPE-J in a Portable Platform for Detecting PA in Nitro Explosives

The portable detection platform included a notebook computer, a closed box, a UV light source, an optical camera, and a sample vial. The small-molecule probe TPE-J or the fluorescent sensor prepared from the small-molecule probe TPE-J was filled in the sample vial. A reaction was conducted in the closed box. The closed box could eliminate the influence of an external light source on fluorescence sensing. A PA-containing substance was added to the sample vial and photographed under a UV light source. A fluorescence image was acquired by the optical camera. The accurate recognition and quantitative detection of PA explosives were allowed through the information analysis of image colors and the resolution of spectral information.

A color information content included a red: R, a green: G, a blue: B, a hue: H, a saturation: S, and a value: V. A captured image was segmented and extracted according to these six image signal channels, and a relationship of RGB and HSV with a PA concentration in a sample was established. As a result, a PA concentration in a sample could be acquired through RGB and HSV of an image. The above process was implemented by a PP-YOLO model.

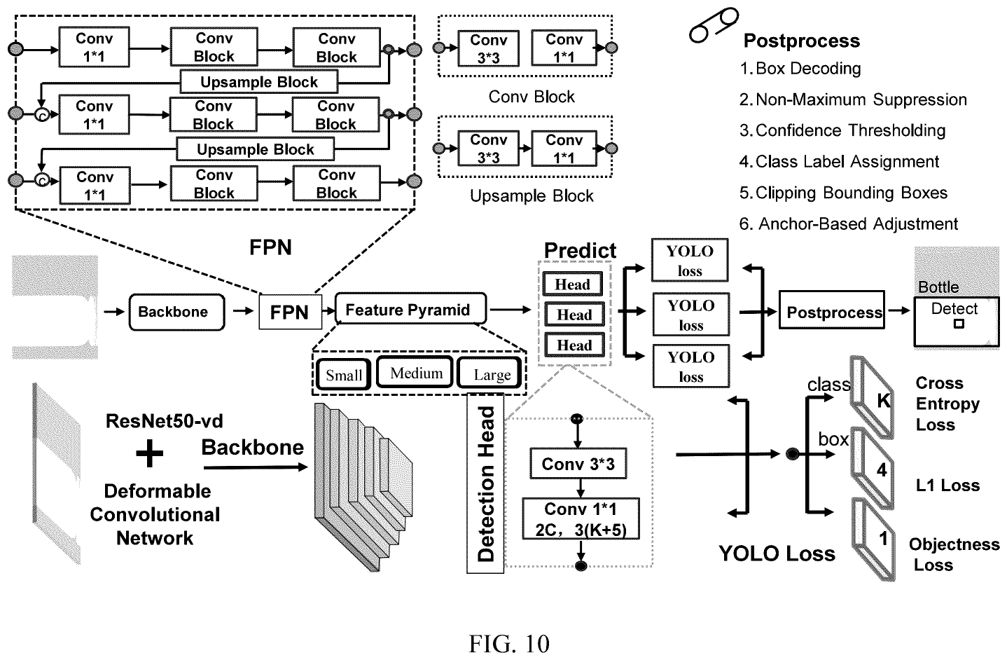

The image processing process shown in FIG. 10: An input image was received by the PP-YOLO model and subjected to feature extraction with a deep convolutional neural network. A representation ability for multi-scale features was enhanced with FPN and PANet. Then, a feature map was processed with a network to predict a class probability and bounding box coordinates of each region. A target was matched with an anchor box, and overlapping predictions were eliminated with NMS. A post-processing step was finally conducted to filter and fine-tune results to obtain a final target detection result.

Specifically, the following steps were included:
1. Input Processing: Image preprocessing included adjusting a size of an image to a fixed size and normalizing to adapt to the needs of a network. At a training stage, data augmentation techniques such as random clipping, rotation, and flipping were adopted to improve a generalization ability of a model.
2. Backbone Network: The PP-YOLO adopted ResNet50 or a similar backbone network as a feature extractor. Such a network typically included a plurality of convolutional layers and pooling layers to capture optical features in an image.

Residual Connections: For example, skip connections introduced in ResNet can help solve the vanishing gradient problem in deep networks and facilitate the flow of information. The backbone adopted ResNet50-vd with a strong feature extraction ability to extract feature maps at different scales. In addition, a deformable convolution network (DCN) was introduced into ResNet50-vd to well deal with the deformation and attitude change of a target, which contributed to improving the accuracy of recognition of the target and enhancing the self-adaptability of the model for the target. This improvement enabled the PP-YOLO to achieve high accuracy while maintaining high efficiency and to be suitable for target detection tasks in diverse scenarios.
3. FPN: FPN constructed multi-scale feature representations by upsampling feature maps at different levels and fusing information of adjacent levels. Situations of different targets could be detected simultaneously. FPN could effectively extract multi-scale features to meet the requirements of target detection across different scales. After a multi-level feature map was acquired from the backbone, three resolution feature levels were formed. After images of different scales were input from a 1*1 convolutional layer, a top-down path was first constructed. Upsample Block was adopted in the backbone network to allow the upsampling of a high-level (shallow but rich semantic) feature map to match a size of a low-level (deep but rich spatial) feature map. A horizontal connection was introduced, and an upsampled feature was fused with a corresponding low-level feature map through the 1*1 convolutional layer to match a channel size. A feature map produced after the fusion was output for the next detection and prediction. The fusion of high-level semantic features with low-level spatial features finally resulted in a multi-scale feature map, which was output by Depthwise Separable Convolution.
4. PANet: PANet further enhanced an effect of FPN. PANet added an additional bottom-top path to enhance the information transmission from a low level to a high level.
5. Head Prediction: A classification head and a regression head were added to feature maps at different scales that were generated by FPN/PANet.

The classification header was responsible for predicting a class probability of an object at each position.

The regression head gave a position offset relative to an anchor box and an aspect ratio change to accurately locate a target. A detection head of PP-YOLO included a 3×3 convolutional layer and a 1×1 convolutional layer, and was configured to improve the feature extraction and channel number adjustment for final prediction. A number of output channels for each final prediction was 3(K+5), where K was a number of classes. Each position on each final predicted map was associated with three different anchors in the next segment. Among the three anchors, a first anchor was for the detection head to predict a class probability of each position. A probability prediction of a class K was output by the first K channels of a convolutional layer. Four channels in a second anchor were responsible for the position prediction of a bounding box, which was completed through the output of four channels in a middle of a convolutional layer. A third anchor was an objective score prediction. A model was often used to predict a quantifiable result based on objective criteria. The accuracy of these prediction results could be verified through the comparison with actual values.
6. Loss Function: The PP-YOLO model adopted different types of loss functions to train the corresponding classification and localization tasks. In order to classify a target and train a model to improve the accuracy of class prediction: Cross entropy loss was adopted to measure a difference between a class probability distribution predicted by a model and an actual class. L1 Loss was sensitive to an absolute value of a distance, and was adopted to measure a distance between a predicted bounding box and an actual bounding box, so as to accurately locate a target. Objectness loss was adopted to monitor whether a model recognizes the presence of a target object. The calculation of objectness loss was usually achieved by binary cross entropy loss, which quantified a difference between a prediction of the presence of an object by a model and an actual scenario. This multi-task learning method enabled a model to complete a target detection task quickly and accurately.
7. Post-Processing: Threshold filtering, bounding box adjustment, class probability assignment, score reordering, output formatting (img/csv), and result visualization.
8. Output Results: Final output: The PP-YOLO model optimized final test results of a model through Postprocess, and a prediction result with high confidence was selected. The output results were formatted into a desired output format (csv or jpg) by an algorithm, and detection results were visualized (images were labeled with bounding boxes and class labels). Through the post-processing step, the PP-YOLO ensures that a model can provide high-quality target detection results, and is suitable for various practical application scenarios.

Through the above process, the PP-YOLO can achieve the rapid target detection with high accuracy. This design is particularly suitable for application scenarios requiring the real-time performance, such as video surveillance and autonomous driving. In this example, a color change of a probe solution in a sample vial was monitored at a rate of 0.1 s/frame, a target recognition region was manually selected in an image by an operator, and RGB/HSV were output by a color extraction function. In addition, image data could be automatically recorded and stored according to a timeline to construct a complete dataset, which could serve as an input for the subsequent deep learning platform.

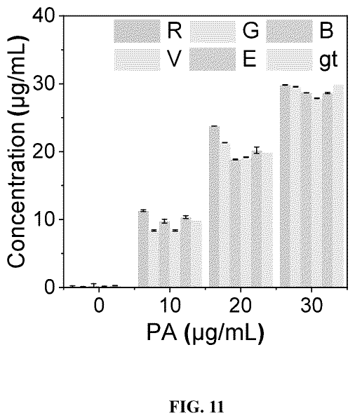

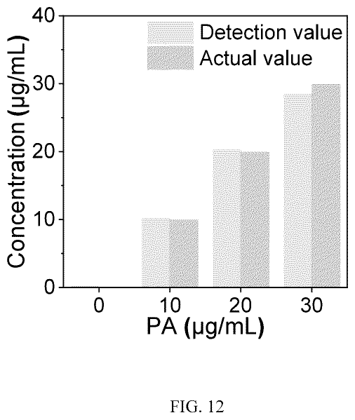

PA samples of different concentrations (0 μg/mL, 10 μg/mL, 20 μg/mL, and 30 μg/mL) were input into a PA detection platform for accuracy verification. Results were shown in FIG. 11 and FIG. 12. The platform could extract R, G, B, V, and E values at each concentration. Analyte concentration values detected by the platform were compared with actual analyte concentration values, and an accuracy could exceed 95%. A fluorescence quenching-concentration curve for PA was further analyzed, and a relationship between image information and target concentrations was established. In addition to deriving RGB signal values from a fluorescence image output, signal output channels were increased and HSV signal values were generated to improve the image processing accuracy.

From a same image processed by the above steps, the same color data could be retrieved by a plurality of image processing platforms such as mobile applications, computer software (Photoshop CC 2018), and cameras, which confirmed that the extraction of RGB values was not affected by differences among different image processing tools. In scenarios where there was no dedicated camera, a smartphone camera could also allow the recognition, making a wide range of application needs met.

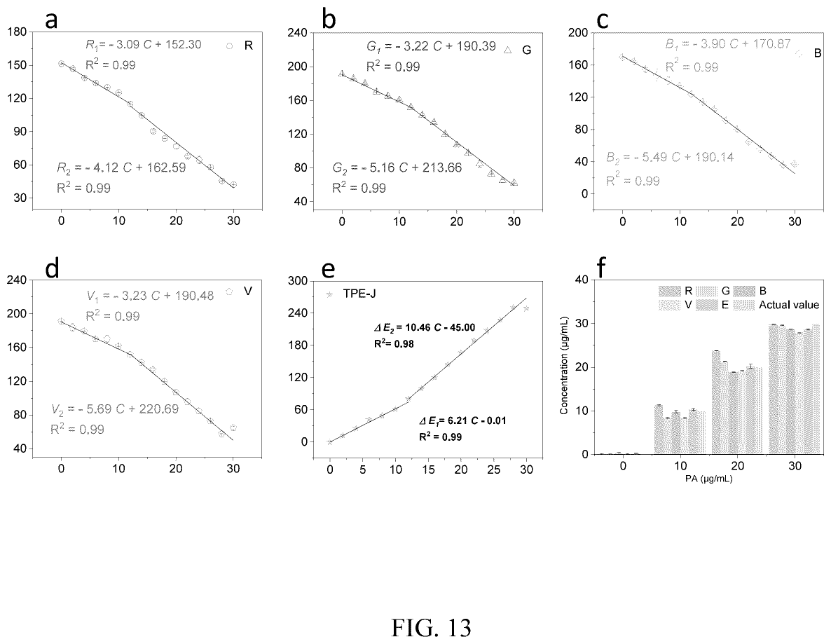

A relationship of RGB and HSV with PA concentrations was determined through the calibration of a standard curve. A linear relationship of RGB and HSV signal values with target concentrations was analyzed through experiments, and results were shown in Table 1 and FIG. 13. It can be seen that R, G, B, and V values all are well correlated linearly with PA concentrations (R²>99). It indicates that the detection platform can accurately determine RGB values through image analysis, and thus can determine a PA concentration. It was found that the correlation between color information and target concentrations was manifested in two different stages. When a PA concentration was in a range of 0 μmg/mL to 10 μmg/mL, a fluorescence quenching degree was obvious, resulting in a significant change in RGB values of an image. When the PA concentration further increased based on the above range, a fluorescence quenching degree changed smoothly, and a relationship between RGB values and PA concentrations exhibited another linear relationship.

In addition, a PA concentration could be detected through visual color perception. A change in visual color perception could be quantified according to the following equation:

$$Δ {E}_{f} = \sqrt{{( {R}_{n} - {R}_{0} )}^{2} + {( {G}_{n} - {G}_{0} )}^{2} + {( {B}_{n} - {B}_{0} )}^{2} + {( {V}_{n} - {V}_{0} )}^{2}}$$

where Rn, Bn, Gn, and Vn represent R, B, G, and V values after a quenching agent is added, respectively, and R0, B0, G0, and V0 represent R, B, G, and V values when no quenching agent is added, respectively. Detection results were shown in e of FIG. 13.

TABLE 1
Evaluation results for PA of different concentrations

| | | | | | | | Difference | |
|---|---|---|---|---|---|---|---|---|
| Actual | | | | | | Test | from actual | Accuracy |
| value | | | | | | value | value | rate |
| (μg/ml) | R | G | B | V | ΔΕ | (μg/ml) | (μg/ml) | (%) |
| 0 | 153.36 | 190.32 | 169.86 | 190.32 | 2.23 | 0.36 | 0.36 | / |
| 10 | 117.32 | 163.39 | 132.75 | 163.39 | 64.24 | 10.34 | 0.34 | 96.6 |
| 20 | 64.68 | 103.55 | 86.71 | 111.55 | 168.85 | 20.45 | 0.45 | 97.8 |
| 30 | 39.73 | 61.10 | 32.66 | 62.29 | 254.61 | 28.64 | 1.36 | 95.5 |

### Example 4 Cloud-Based Intelligent Visual Detection System

The method for color analysis of a fluorescence image in the PA detection platform in Example 3 is deployed on a cloud platform, and accordingly, a plurality of detection platforms and a plurality of detection sites could be covered through open interfaces of the cloud platform. As a result, a plurality of detection terminals can be unified and standardized, and the real-time data transmission and data sharing can be achieved, which is conducive to establishing a huge database and provides precious resources for the future model training and updating. In addition, a plurality of mobile terminals can be connected to the cloud platform by establishing cloud websites, which increases the ways to detect explosives. The PP-YOLO model performs the training and the automatic learning and updating based on a dataset collected in a cloud to improve the efficiency and accuracy of target detection.

In this example, PaddlePaddle is adopted as an open-source platform. A PP-YOLO target detection model based on a PaddlePaddle deep learning platform represents an enhanced version of a You Only Look Once (YOLO) algorithm. The YOLO algorithm is widely praised for a speed and performance, is especially suitable for real-time processing scenarios, and effectively solves the practical needs of PA detection. PP-YOLO is produced through the optimization and upgrading on the basis of YOLO, and can improve the detection accuracy and speed. The intelligent real-time monitoring system for nitro explosives in this example adopts a PP-YOLO algorithm, and can capture fluorescence and colorimetric images with the assistance of an optical camera. The fluorescent probe (TPE-J) including a TPE fragment and a thieno[3,4-b] group is designed and synthesized for the dosage-sensitive and visual detection of nitro explosives (PA). The electron transfer between PA and the probe causes a specific response that the original blue fluorescence is rapidly quenched to non-luminescence within 5 s, with a detection limit as low as 1 mg/mL. A mechanism of a competitive reaction between the detector and the fluorescent sensor is discussed through DFT. A color change can be integrated into an optical camera for capture and quantization, and the resulting image data is automatically processed by a deep learning algorithm platform. The sensing system facilitates the efficient real-time monitoring and highly-sensitive detection of PA in various scenarios. The portable fluorescence sensing platform with deep learning provides a new perspective for the efficient portable detection of explosives.

It is apparent for those skilled in the art that the present disclosure is not limited to details of the above exemplary embodiments, and that the present disclosure may be implemented in other specific forms without departing from the spirit or basic features of the present disclosure. Therefore, the embodiments should be regarded as exemplary rather than restrictive from any point of view.

What is claimed is:

1. A molecule probe based on fluorescence sensing, wherein a structure of the molecule probe is as follows:

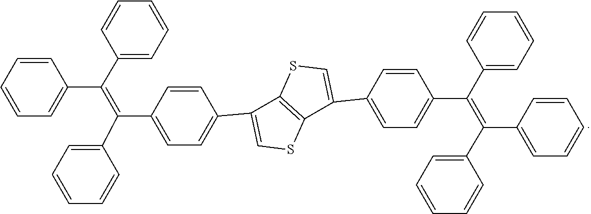 [SMILES: c1ccc(C(=C(c2ccccc2)c2ccc(-c3csc4c(-c5ccc(C(=C(c6ccccc6)c6ccccc6)c6ccccc6)cc5)csc34)cc2)c2ccccc2)cc1]

2. A synthesis method of the molecule probe according to claim 1, comprising:
degassing a mixture of 3,4-dibromothiophene, (4-(1,2,2-triphenylvinyl)phenyl)boronic acid, toluene, potassium carbonate, distilled water, tetrakis(triphenylphosphine)palladium, and absolute ethanol to produce a degassed mixture, and
subjecting the degassed mixture to stirring and reflux at 90° C. under nitrogen for 24 h.

3. The synthesis method according to claim 2, wherein the 3,4-dibromothiophene, the (4-(1,2,2-triphenylvinyl)phenyl)boronic acid, and the potassium carbonate are in a molar ratio of 1:3:8; the toluene, the distilled water, and the absolute ethanol are in a volume ratio of 6:4:3; 0.75 mL of the toluene is required per millimole of the potassium carbonate; and an equivalent of the tetrakis(triphenylphosphine)palladium is 0.02 times an equivalent of the 3,4-dibromothiophene.

4. A fluorescent sensor immobilized with the molecule probe according to claim 1.

5. The fluorescent sensor according to claim 4, wherein the fluorescent sensor is a paper-based fluorescent sensor or a hydrogel-based thin-film fluorescent sensor.

6. A portable explosive detection platform, comprising a notebook computer, a closed box, an ultraviolet (UV) light source, an optical camera, and a sample vial, wherein the sample vial is filled with the fluorescent sensor according to claim 5.

7. A portable explosive detection platform, comprising a notebook computer, a closed box, an ultraviolet (UV) light source, an optical camera, and a sample vial, wherein the sample vial is filled with the molecule probe according to claim 1.

8. A method for quantifying a picric acid (PA) content based on a fluorescence image-derived spectrum, comprising:
allowing the portable explosive detection platform according to claim 6 to bind to PA;
taking images by an optical camera;
extracting RGB values from the images;
establishing a linear relationship of RGB and Hue, Saturation, Value (HSV) with PA concentrations; and
calculating the PA content qualitatively and quantitatively through an equation for the linear relationship.

9. The method according to claim 8, wherein image processing is conducted with a PP-YOLO model as follows:
receiving input images by the PP-YOLO model, and conducting feature extraction with a deep convolutional neural network;
enhancing a representation ability for multi-scale features with a feature pyramid network (FPN) and a path aggregation network (PANet);
processing a feature map with a network to predict a class probability and bounding box coordinates of each region;
matching a target with an anchor box, and eliminating overlapping predictions with non-maximum suppression (NMS); and
conducting a post-processing step to filter and fine-tune results to obtain a final object detection result.

10. A method for quantifying a picric acid (PA) content based on a fluorescence image-derived spectrum, comprising:
allowing the fluorescent sensor according to claim 4 to bind to PA;
taking images by an optical camera;
extracting RGB values from the images;
establishing a linear relationship of RGB and Hue, Saturation, Value (HSV) with PA concentrations; and
calculating the PA content qualitatively and quantitatively through an equation for the linear relationship.

11. The method according to claim 10, wherein image processing is conducted with a PP-YOLO model as follows:
receiving input images by the PP-YOLO model, and conducting feature extraction with a deep convolutional neural network;
enhancing a representation ability for multi-scale features with a feature pyramid network (FPN) and a path aggregation network (PANet);
processing a feature map with a network to predict a class probability and bounding box coordinates of each region;
matching a target with an anchor box, and eliminating overlapping predictions with non-maximum suppression (NMS); and
conducting a post-processing step to filter and fine-tune results to obtain a final object detection result.

12. A method for quantifying a picric acid (PA) content based on a fluorescence image-derived spectrum, comprising:
allowing the molecule probe according to claim 1 to bind to PA;
taking images by an optical camera;
extracting RGB values from the images;
establishing a linear relationship of RGB and Hue, Saturation, Value (HSV) with PA concentrations; and
calculating the PA content qualitatively and quantitatively through an equation for the linear relationship.

13. The method according to claim 12, wherein image processing is conducted with a PP-YOLO model as follows:
receiving input images by the PP-YOLO model, and conducting feature extraction with a deep convolutional neural network;
enhancing a representation ability for multi-scale features with a feature pyramid network (FPN) and a path aggregation network (PANet);
processing a feature map with a network to predict a class probability and bounding box coordinates of each region;
matching a target with an anchor box, and eliminating overlapping predictions with non-maximum suppression (NMS); and
conducting a post-processing step to filter and fine-tune results to obtain a final object detection result.

14. A cloud-based intelligent visual detection system comprising a cloud platform embedded with instructions for implementing the method according to claim 8.
